(19) United States
(12) Patent Application Publication
(10) Pub. No.: US 2018/0157744 A1
(43) Pub. Date: Jun. 7, 2018

(54) COMPARISON TABLE AUTOMATIC GENERATION METHOD, DEVICE AND COMPUTER PROGRAM PRODUCT OF THE SAME

(71) Applicant: INSTITUTE FOR INFORMATION INDUSTRY, Taipey (TW)

(72) Inventors: Ping-I CHEN, Taipei City (TW); Tai-Ta KUO, Taoyuan City (TW); Yen-Heng TSAO, New Taipei City (TW); Yu-Chuan YANG, Taichung City (TW)

(21) Appl. No.: 15/604,677

(22) Filed: May 25, 2017

(30) Foreign Application Priority Data
Dec. 2, 2016 (TW) 105139987

(51) Int. Cl. G06F 17/30; G06F 17/27

(52) U.S. Cl. CPC G06F 17/30707; G06F 17/30616; G06F 17/277; G06F 17/30864; G06F 17/30684

(57) ABSTRACT

A comparison table automatic generation method that includes the steps outlined below is provided. An interface is provided to set comparison topics, a basic article, a basic article object and marked paragraphs. Correlation between basic article words of the marked paragraphs is calculated to generate a marked main tag and marked enriched words to further retrieve collected article and a collected article object accordingly. Correlation between collected article words of the collected article paragraphs are calculated to generate main tag and enriched words of collected article to be compared with the marked main tag and the marked enriched words to calculate a similarity to further generate selected paragraphs accordingly. A comparison table that includes the comparison topics, the basic and collected article objects as the items of rows and columns therein is established such that the marked and the selected paragraphs are filled in entries of the comparison table.

### RELATED APPLICATIONS

This application claims priority to Taiwan Application Serial Number 105139987, filed Dec. 2, 2016, which is herein incorporated by reference.

### BACKGROUND

### Field of Invention

The present invention relates to a data processing technology. More particularly, the present invention relates to a comparison table automatic generation method, a comparison table automatic generation device and a computer product of the same.

### Description of Related Art

Along with the development of the network, a user can easily access a large amount of information through the network. However, when the user wants to make comparison based on a specific topic and make a related comparison table, a manual search of the information on the network is unavoidable. For example, the user may need to read a multiple of network articles and seek for the identical topics and the corresponding contents to make comparison. Subsequently, the user has to select the required information so as to make the table manually. The comparison made manually is time-consuming and exhausting and the efficiency is low. It is impossible to integrate a large amount of data rapidly.

Accordingly, what is needed is a comparison table automatic generation method, a comparison table automatic generation device and a computer product of the same to address the above issues.

### SUMMARY

The invention provides a comparison table automatic generation method implemented by a server. The comparison table automatic generation method includes the steps outlined below. A setting of a plurality of comparison topics, a basic article, a basic article object and a plurality of marked paragraphs are received through an interface unit, wherein each of the marked paragraphs is selected from a paragraph of the basic article and is marked by one of the comparison topics. The server is controlled to calculate a first correlation between each of a plurality of basic article words comprised in each of the marked paragraphs and generate at least one marked main tag and a plurality of marked enriched words corresponding to each of the marked paragraphs. The server is controlled to retrieve a collected article and a collected article object from an information source according to the marked main tag and the marked enriched words. The server is controlled to calculate a second correlation between each of a plurality of collected article words comprised in each of a plurality of collected article paragraphs and generate at least one main tag of collected article paragraph and a plurality of extend words of collected article paragraph. The server is controlled to generate a similarity by comparing the main tag of collected article paragraph and the extend words of collected article paragraph of each of the collected article paragraphs and the marked main tag and the marked enriched words of each of the marked paragraphs. The server is controlled to select a selected paragraph corresponding to each of the comparison topics from each of the collected article paragraphs according to the similarity. The server is controlled to establish a comparison table, wherein each of the comparison topics serves as a content of each of a plurality of rows of the comparison table and the basic article topic serves as the content of one of a plurality of columns of the comparison table. The server is controlled to mark the marked paragraphs corresponding to each of the comparison topics in the basic article to entries of the rows corresponding to each of the comparison topics within the column. The server is controlled to use the collected article object as the content of another one of the plurality of columns of the comparison table. The server is controlled to mark the selected paragraph corresponding to each of the comparison topics in the collected article to the entries of the rows corresponding to each of the comparison topics within the column.

Another aspect of the present invention is to provide a comparison table automatic generation device that includes a storage unit and a processing unit. The storage unit is configured to store an application program. The processing unit is electrically coupled to the storage unit and is configured to execute the application program to generate a comparison table automatically according to a basic article and a connected article collected within a time period. The processing unit provides an interface unit to receive a setting of a plurality of comparison topics, the basic article, a basic article object and a plurality of marked paragraphs, wherein each of the marked paragraphs is selected from a paragraph of the basic article and is marked by one of the comparison topics, calculates a first correlation between each of a plurality of basic article words comprised in each of the marked paragraphs and generate at least one marked main tag and a plurality of marked enriched words corresponding to each of the marked paragraphs, retrieves the collected article and a collected article object from an information source according to the marked main tag and the marked enriched words, calculates a second correlation between each of a plurality of collected article words comprised in each of a plurality of collected article paragraphs and generate at least one main tag of collected article paragraph and a plurality of extend words of collected article paragraph, generate a similarity by comparing the main tag of collected article paragraph and the extend words of collected article paragraph of each of the collected article paragraphs and the marked main tag and the marked enriched words of each of the marked paragraphs, selects a selected paragraph corresponding to each of the comparison topics from each of the collected article paragraphs according to the similarity and establishes the comparison table, wherein each of the comparison topics serves as a content of each of a plurality of rows of the comparison table and the basic article topic serves as the content of one of a plurality of columns of the comparison table. The server is controlled to mark the marked paragraphs corresponding to each of the comparison topics in the basic article to entries of the rows corresponding to each of the comparison topics within the column. The server is controlled to use the collected article object as the content of another one of the plurality of columns of the comparison table. The server is controlled to mark the selected paragraph corresponding to each of the comparison topics in the collected article to the entries of the rows corresponding to each of the comparison topics within the column.

Yet another aspect of the present invention is to provide a computer program product configured to execute a comparison table automatic generation method implemented by a server. The comparison table automatic generation method includes the steps outlined below. A setting of a plurality of comparison topics, a basic article, a basic article object and a plurality of marked paragraphs are received through an interface unit, wherein each of the marked paragraphs is selected from a paragraph of the basic article and is marked by one of the comparison topics. The server is controlled to calculate a first correlation between each of a plurality of basic article words comprised in each of the marked paragraphs and generate at least one marked main tag and a plurality of marked enriched words corresponding to each of the marked paragraphs. The server is controlled to retrieve a collected article and a collected article object from an information source according to the marked main tag and the marked enriched words. The server is controlled to calculate a second correlation between each of a plurality of collected article words comprised in each of a plurality of collected article paragraphs and generate at least one main tag of collected article paragraph and a plurality of extend words of collected article paragraph. The server is controlled to generate a similarity by comparing the main tag of collected article paragraph and the extend words of collected article paragraph of each of the collected article paragraphs and the marked main tag and the marked enriched words of each of the marked paragraphs. The server is controlled to select a selected paragraph corresponding to each of the comparison topics from each of the collected article paragraphs according to the similarity. The server is controlled to establish a comparison table, wherein each of the comparison topics serves as a content of each of a plurality of rows of the comparison table and the basic article topic serves as the content of one of a plurality of columns of the comparison table so as to control the server to mark the marked paragraphs corresponding to each of the comparison topics in the basic article to entries of the rows corresponding to each of the comparison topics within the column and to control the server to use the collected article object as the content of another one of the plurality of columns of the comparison table and to mark the selected paragraph corresponding to each of the comparison topics in the collected article to the entries of the rows corresponding to each of the comparison topics within the column.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a comparison table automatic generation device in an embodiment of the present invention;

FIG. 2 is a flow chart of a comparison table automatic generation method in an embodiment of the present invention;

FIG. 3A is a diagram of a basic article in an embodiment of the present invention;

FIG. 3B is a diagram of the set comparison topic, the marked main tag and the marked enriched word of the basic article in an embodiment of the present invention;

FIG. 4A is a diagram of the collected article in an embodiment of the present invention;

FIG. 4B is a diagram of the retrieved main tag of collected article paragraph and the extend words of collected article paragraph of the collected article in an embodiment of the present invention; and

FIG. 5 is a diagram of the comparison table in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

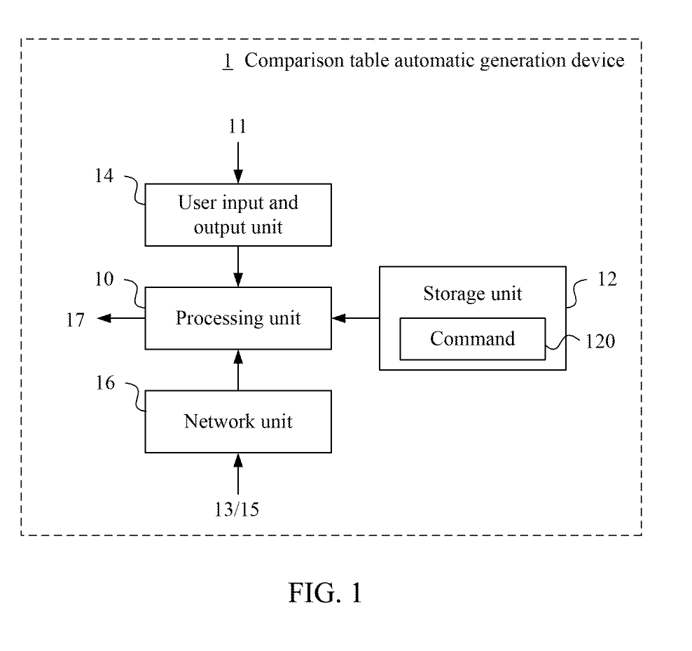

Reference is now made to FIG. 1. FIG. 1 is a block diagram of a comparison table automatic generation device 1 in an embodiment of the present invention. The comparison table automatic generation device 1 includes a processing unit 10, a storage unit 12, a user input and output interface 14 and a network unit 16. In an embodiment, the comparison table automatic generation device 1 can be a computer host or a server and can be accessed or operated by a user through an interface or a remote network host.

The processing unit 10 is electrically coupled to the storage unit 12, the user input and output interface 14 and the network unit 16. The processing unit 10 can be any processor that has operation ability and can perform data transmission with the units mentioned above through various data transmission paths. The storage unit 12 may include one or more than one storage components in different formats, such as but not limited to a read only memory, a flash memory, a floppy disc, a hard disc, an optical disc, a flash disc, a tape, a database accessible from a network or other types of memories.

In an embodiment, the user input and output interface 14 includes an output component, such as but not limited to a display unit to generate a display frame according to the control of the processing unit 10. Further, the user input and output interface 14 may include an input component, such as but not limited to a mouse, a keyboard or other devices or hardware that can receive a user input 11 to transmit a command to the processing unit 10 according to the operation of the user.

The network unit 16 can be connected to a network (not illustrated), such as but not limited to a local area network or the internet. The processing unit 10 can perform communication with other remote host through the network by using the network unit 16.

It is appreciated that the units mentioned above are merely an example. In other embodiments, the comparison table automatic generation device 1 may include other types of units.

The storage unit 12 stores a plurality of computer executable commands 120. When the commands 120 is executed by the processing unit 10, the command 120 functions as a plurality of modules to execute and provide the function of the comparison table automatic generation device 1. In an embodiment, the processing unit 10 operates the comparison table automatic generation device 1 by receiving the user input 11 through the user input and output interface 14. The following paragraphs illustrate the operations of the comparison table automatic generation device 1 executed by the processing unit 10.

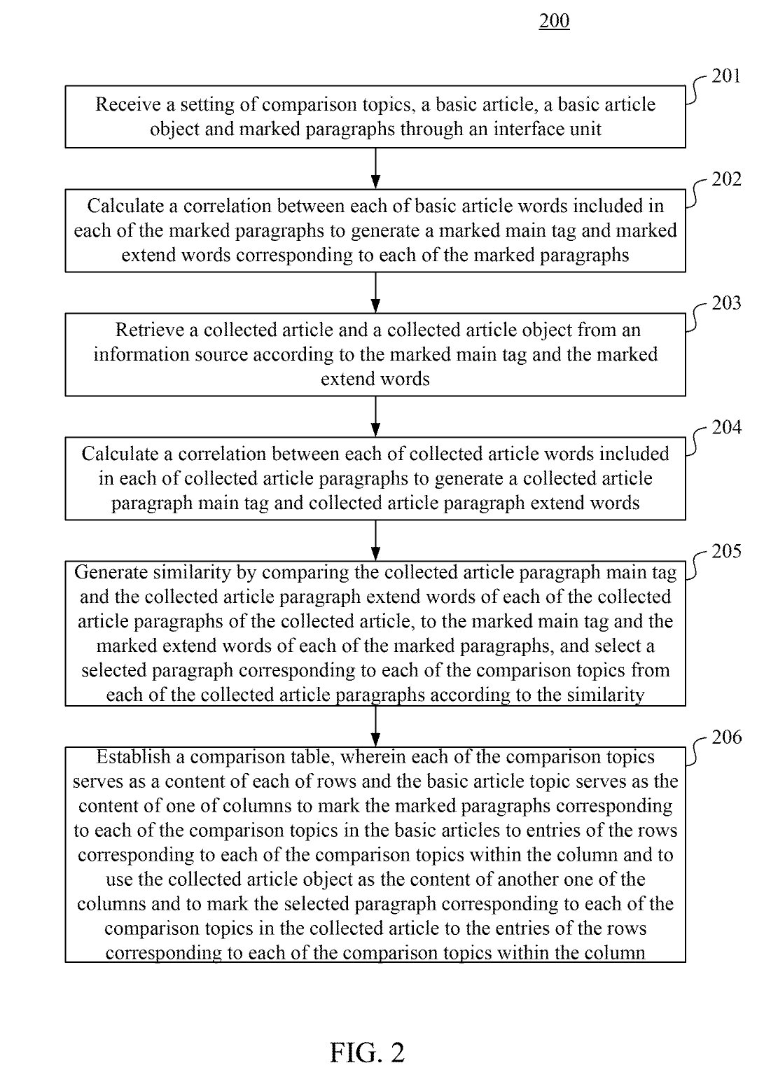

Reference is now made to FIG. 2. FIG. 2 is a flow chart of a comparison table automatic generation method 200 in an embodiment of the present invention. The comparison table automatic generation method 200 can be used in the comparison table automatic generation device 1 illustrated in FIG. 1 or implemented by such as a database or general processor, a computer, server, other hardware devices having unique specific logic circuits or other hardware elements with specific function equipment, e.g. an integration of a program code and a processor/chip into a unique hardware. This method may be implemented as a computer product program to perform the comparison table automatic generation method 200. The computer product program may be a read-only memory, flash memory, floppy disk, hard disk, portable disk, tape, network accessible database or the storage unit that those skill in the art can easily think of.

The comparison table automatic generation method 200 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, a setting of a plurality of comparison topics, a basic article 13, a basic article object and a plurality of marked paragraphs are received through an interface unit. In an embodiment, the interface unit may include the above-mentioned user input and output interface 14, the network unit 16 or a combination of the above. The basic article can be a part or all of a network article, a part or all of a network news, a part or all of a document in a database or a text from a wall of a social media network.

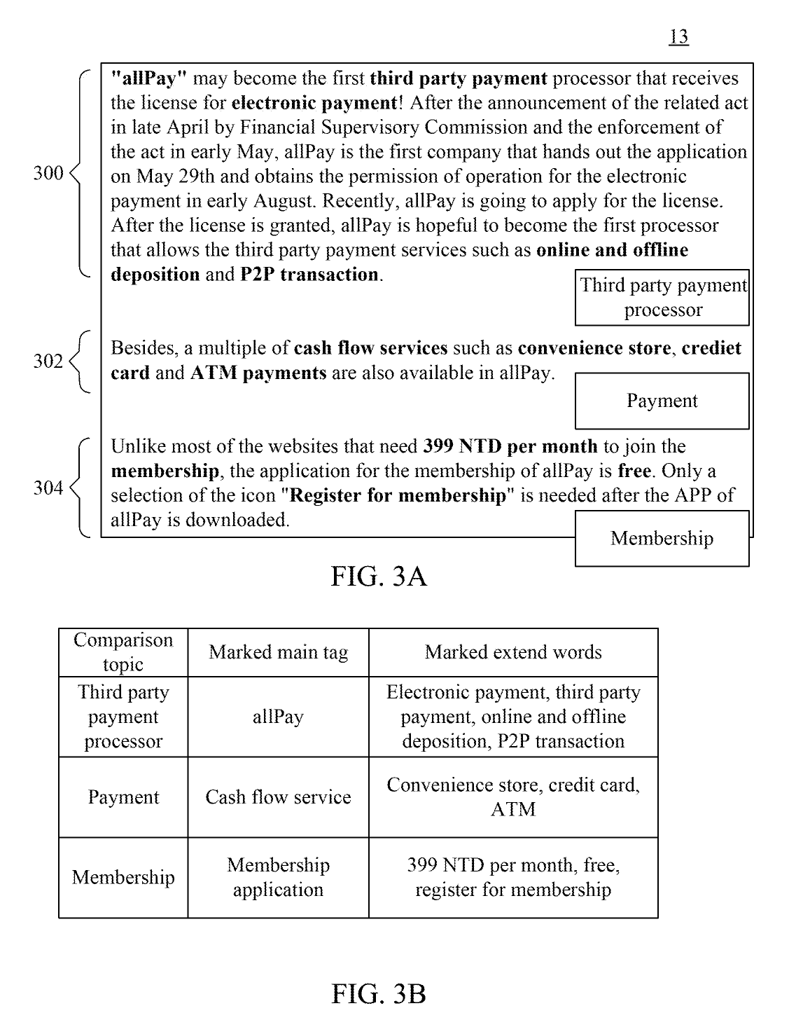

Reference is now made to FIG. 3A. FIG. 3A is a diagram of a basic article 13 in an embodiment of the present invention.

In an embodiment, the basic article 13 retrieve from an information source or a data base in the network through the network unit 16 after the user operates the user input and output interface 14. In the present embodiment, the content of the basic article 13 is related to a third party payment processor “allPay” and includes the content of the third party payment service, the payment method of the third party payment service, the membership participating method and membership type. It is appreciated that the content of the basic article 13 is merely an example. In other embodiments, the basic article 13 may include other contents.

In an embodiment, by using the user input and output interface 14, the basic article object of the basic article 13 is set to be “allPay” and a plurality of comparison topics are set, such as but not limited to the third party payment processor, the payment and the type of membership.

Further, each of the marked paragraphs is selected from a paragraph of the basic article 13 and is marked by one of the comparison topics. For example, the content of the paragraph 300 of the basic article 13 in FIG. 3A is related to the role of allPay serving as an electronic payment method. As a result, the paragraph 300 can be marked by “third party payment processor” after being selected. The content of the paragraph 302 of the basic article 13 is related to the payment of allPay. As a result, the paragraph 302 can be marked by “payment” after being selected. The content of the paragraph 304 of the basic article 13 is related to the membership of allPay. As a result, the paragraph 304 can be marked by “membership” after being selected.

In step 202, the processing unit 10 calculates a correlation between each of a plurality of basic article words included in each of the marked paragraphs 300˜304 to generate a marked main tag and marked enriched words corresponding to each of the marked paragraphs 300˜304.

In an embodiment, the processing unit 10 calculates a normalized Google distance (NGD) of each of the basic article words to calculate the first correlation between each of the basic article words.

Take the paragraph 302 as an example, by using the text segmentation, the processing unit 10 can retrieve the basic article words such as “besides”, “also”, “provide”, “convenience store”, “credit card”, “ATM” and “cash flow service”.

The processing unit 10 further searches each pair of these basic article words on Google by using the network unit 16 to obtain the correlation thereof by calculating the normalized Google distance. For example, the normalized Google distance of “cash flow service” and “besides” is 0.45. The normalized Google distance of “cash flow service” and “also” is 0.35. The normalized Google distance of “cash flow service” and “provide” is 0.6. The normalized Google distance of “cash flow service” and “convenience store” is 0.91. The normalized Google distance of “cash flow service” and “credit card” 0.98. The normalized Google distance of “cash flow service” and “ATM” is 0.97. The normalized Google distances of each pair of the basic article words are used to determine the level of the correlation.

As a result, the basic article words in the paragraph 302 that are more important can be retrieved by the basic article words having the correlations larger than a correlation threshold. For example, when the correlation threshold is set to be 0.7, the pairs of the basic article words of “cash flow service” and “besides”, “cash flow service” and “also” and “cash flow service” and “provide” are excluded. The pairs of the basic article words of “cash flow service” and “convenience store”, “cash flow service” and “credit card” and “cash flow service” and “ATM” are retrieved.

When the basic article words having the correlations is larger than the correlation threshold, the processing unit 10 further retrieves the marked main tag by using a k-core algorithm or a pagerank algorithm. The k-core algorithm or the pagerank algorithm is able to find the basic article word that has the highest correlation with the other basic article words within the retrieved basic article words.

For example, the basic article words “convenience store”, “credit card”, “ATM” and “cash flow service” are highly related to each other. However, the total correlation of “cash flow service” with other basic article words is the highest. As a result, “cash flow service” is determined to be the marked main tag of the paragraph 302 by the processing unit 10. The other basic article words “convenience store”, “credit card” and “ATM” are determined to be the marked enriched words.

It is appreciated that the correlation determining technology described above is merely an example. In other embodiments, other methods for calculating the correlation can be used. The present invention is not limited thereto.

In an embodiment, the processing unit 10 performs a search in the search engine by using the network unit 16 according to the marked enriched words to generate a search result page with a plurality of search result words. One of the search result words are categorized into the marked enriched words by the processing unit when an importance value of the one of the plurality of search result words is larger than a importance threshold.

More specifically, after the processing unit 10 performs the search in the search engine according to the marked enriched words, the text segmentation is performed on the texts of the top 20 search results to calculate the importance. In an embodiment, the importance is determined by an occurrence frequency of the texts calculated by a ratio of the number of each of the texts and the number of all the texts. When the occurrence frequency is larger than a predetermined importance threshold value, the text is added into the marked enriched words.

Reference is now made to FIG. 3B. FIG. 3B is a diagram of the set comparison topic, the marked main tag and the marked enriched word of the basic article 13 in an embodiment of the present invention.

By the setting described above, the marked paragraph of the basic article 13 can be simplified as the table illustrated in FIG. 3B. The paragraph 300 corresponds to the comparison topic of “third party payment processor”, includes the marked main tag of “allPay” and includes the marked enriched words of “electronic payment”, “third party payment”, “online and offline deposition” and “P2P transaction”. The paragraph 302 corresponds to the comparison topic of “payment”, includes the marked main tag of “cash flow service” and includes the marked enriched words of “convenience store”, “credit card” and “ATM”. The paragraph 304 corresponds to the comparison topic of “membership”, includes the marked main tag of “membership application” and includes the marked enriched words of “399 NTD per month”, “free”, “register for membership”.

In step 203, the processing unit 10 retrieves a collected article 15 and a collected article object from an information source according to the marked main tag and the marked enriched words within a specific time interval.

In an embodiment, the information source can be the storage unit 12 in the comparison table automatic generation device 1 or the network server and database accessible by the network unit 16. According to the marked main tag and the marked enriched words in FIG. 3B, the processing unit 10 retrieves the collected article 15 and the collected article object within the specific time interval. In an embodiment, the collected article object can also be set by using the user input and output interface 14. The collected article object can be the objects related to the third party payment, such as but not limited to “Yahoo” and “PCHome”.

The length of the time interval can be set by the user. For example, the processing unit 10 can retrieve the articles within a week, a month or half a year as the collected article 15.

In step 204, the processing unit 10 calculates a correlation between each of a plurality of collected article words included in each of collected article paragraphs to generate a main tag of collected article paragraph and extend words of collected article paragraph.

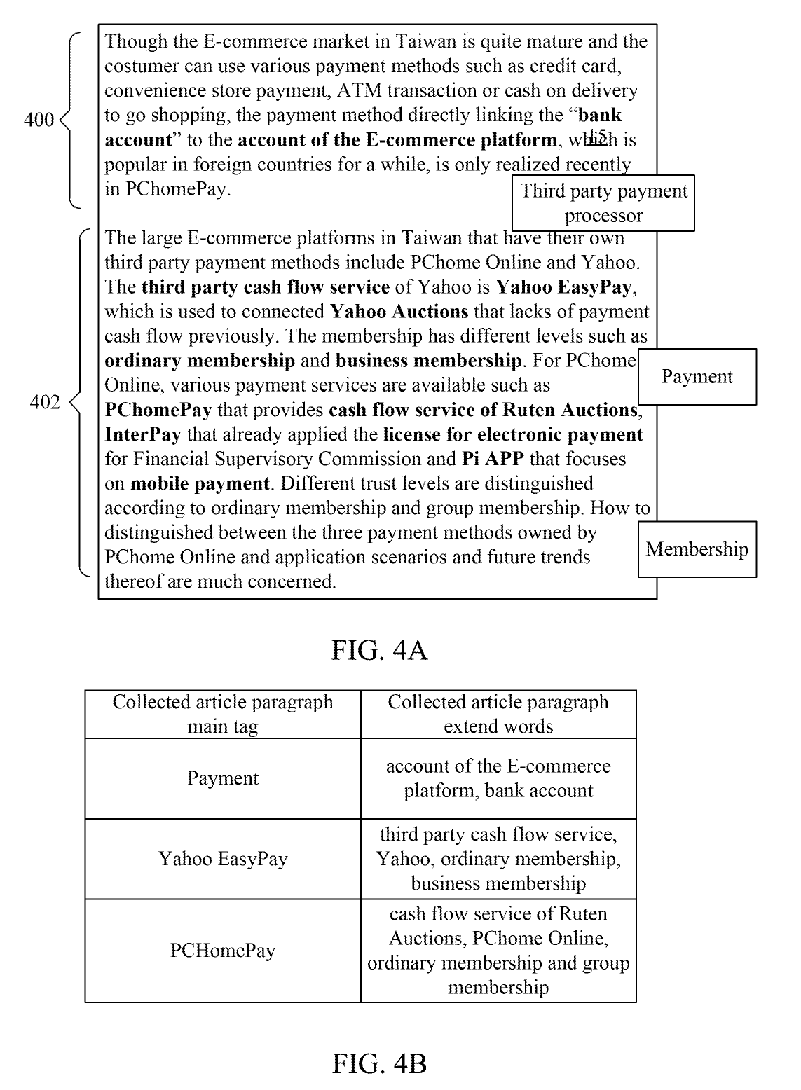

Reference is now made to FIG. 4A. FIG. 4A is a diagram of the collected article 15 in an embodiment of the present invention.

In the present embodiment, the collected article 15 includes paragraphs 400 and 402. The content thereof are related to the third party payment processors of “Yahoo” and “PCHomePay” and include the contents of the third party payment processors, the payment methods of the third party payment processors, the types of membership and the methods to join the membership. It is appreciated that the content of the collected article 15 is merely an example. In other embodiments, the collected article 15 may include other contents.

Similar to the processing performed on the basic article 13 by the processing unit 10, the processing unit 10 performs text segmentation on the collected article 15, calculates the correlation thereof and generates a main tag of collected article paragraph and extend words of collected article paragraph of the collected article 15. As a result, the detail of the process is not described herein.

Reference is now made to FIG. 4B. FIG. 4B is a diagram of the retrieved main tag of collected article paragraph and the extend words of collected article paragraph of the collected article 15 in an embodiment of the present invention.

For example, as illustrated in FIG. 4B, the main tag of collected article paragraph of the paragraph 400 is “payment” and the corresponding extend words of collected article paragraph include “account of the E-commerce platform” and “bank account”. The main tag of collected article paragraph of the paragraph 402 is “Yahoo EasyPay” and the corresponding extend words of collected article paragraph include “third party cash flow service”, “Yahoo” and “ordinary membership and business membership”. The other main tag of collected article paragraph of the paragraph 402 is “PCHomePay” and the corresponding extend words of collected article paragraph include “cash flow service of Ruten Auctions”, “PChome Online” and “ordinary membership and group membership”.

In step 205, the processing unit 10 generates a similarity by comparing the main tag of collected article paragraph and the extend words of collected article paragraph of each of the collected article paragraphs of the collected article 15, to the marked main tag and the marked enriched words of each of the marked paragraphs. The processing unit 10 further selects a selected paragraph corresponding to each of the comparison topics from each of the collected article paragraphs 400 and 402 according to the similarity.

In an embodiment, the processing unit 10 calculates a normalized Google distance according to the main tag of collected article paragraph of each of the paragraphs 400 and 402 in FIG. 4B and the marked main tag of each of the paragraphs 300, 302 and 304 in FIG. 3B and calculates a cosine similarity according to the extend words of collected article paragraph of each of the paragraphs 400 and 402 in FIG. 4B and the marked enriched words of each of the paragraphs 300, 302 and 304 in FIG. 3B.

The cosine similarity is one of the most popular similarity calculation methods used in the field of information retrieval that is used to calculate the similarity between the documents or the words. In an embodiment, the processing unit 10 expresses the extend words of collected article paragraph and the marked enriched words as vectors, takes the basic article 13 and the collected article 15 as the dimensions and takes the respective weighting values of the extend words of collected article paragraph and the marked enriched words in the basic article 13 and the collected article 15 as the dimension value to calculate the cosine similarity.

Subsequently, the processing unit 10 generates the similarity between the paragraphs 400 and 402 and the paragraphs 300, 302 and 304 according to the normalized Google distance and the cosine similarity.

In an embodiment, the processing unit 10 respectively performs a sum of all of weight summation of the normalized Google distance and the cosine similarity according to a predetermined first weighting value and a predetermined second weighting value to generate the similarity. For example, when the normalized Google distance of the main tag of collected article paragraph and the marked main tag is Simₘₜ, the cosine similarity of the extend words of collected article paragraph and the marked enriched words is Sim_{ew}, and the first and the second weighting values are α and β, the similarity can be expressed as Sim=α×Simₘₜ+β×Sim_{ew}.

Subsequently, the processing unit 10 determines that the comparison topic of a collected article paragraph and the comparison topic of a basic article paragraph are the same when a value of the similarity is larger than a predetermined similarity threshold value. As a result, by calculating the similarity, the processing unit 10 determines the paragraphs that correspond to the same comparison topic in the basic article 13 and the collected article 15.

For example, the paragraph 302 of the basic article 13 and the paragraph 402 of the collected article 15 are both highly related to the cash flow and the payment. After the calculation of the similarity, the processing unit 10 determines that the paragraphs 302 and 402 both correspond to the comparison topic of “payment”. As a result, the processing unit 10 selects the paragraph 402 as a selected paragraph corresponding to the comparison topic of “payment”.

In step 206, the processing unit 10 establishes a comparison table 17.

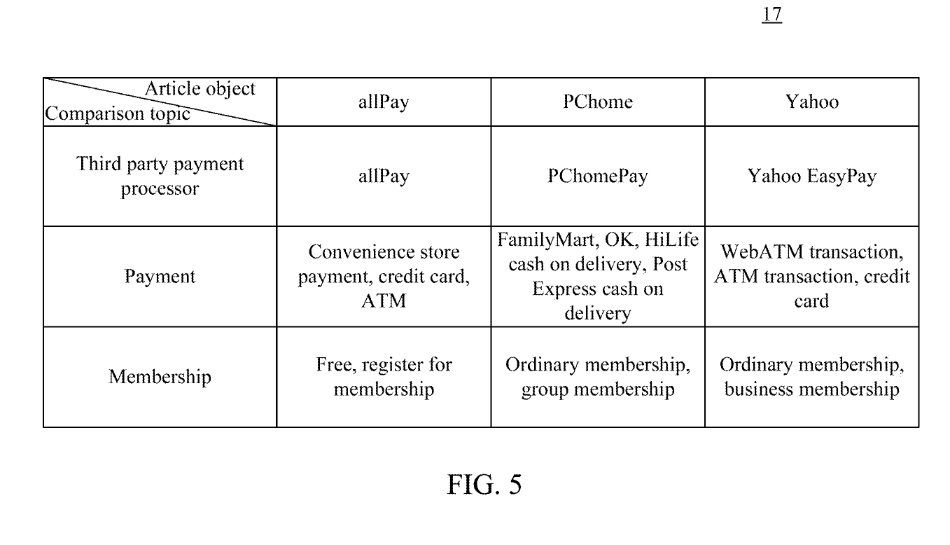

Reference is now made to FIG. 5. FIG. 5 is a diagram of the comparison table 17 in an embodiment of the present invention.

Each of the comparison topics serves as a content of each of a plurality of rows of the comparison table 17. As illustrated in FIG. 5, the contents of the rows of the comparison table 17 are “third party payment processor”, “payment” and “membership”. Subsequently, the processing unit 10 uses the basic article object as the content of the first column. As a result, as illustrated in FIG. 5, the content of the first column of the comparison table 17 is “allPay”.

Further, the processing unit 10 marks the marked paragraphs corresponding to each of the comparison topics in the basic article 13 to entries of the rows corresponding to each of the comparison topics within the column. It is appreciated that in different embodiments, the processing unit 10 can selectively mark all the words in the marked paragraph, sentences of a part of the paragraph or keywords (e.g. that marked enriched words) of part of the paragraph in the entries.

As a result, as illustrated in FIG. 5, corresponding to the comparison topic of “third party payment processor” in the first row, the processing unit 10 will mark “allPay” in the entry corresponding to the first column. Corresponding to the comparison topic of “payment” in the second row, the processing unit 10 will mark “convenience store payment, credit card, ATM” in the entry corresponding to the first column. Corresponding to the comparison topic of “membership” in the third row, the processing unit 10 will mark “free, register for membership” in the entry corresponding to the first column.

The processing unit 10 uses the collected article object as the content of the second column of the comparison table 17. As a result, as illustrated in FIG. 5, the second column of the comparison table 17 uses “PCHome” as the content.

Further, the processing unit 10 marks the selected paragraph corresponding to each of the comparison topics in the collected article to the entries of the rows corresponding to each of the comparison topics within the second column.

As illustrated in FIG. 5, corresponding to the comparison topic of “third party payment processor” in the first row, the processing unit 10 will mark “PChomePay” in the entry corresponding to the second column. Corresponding to the comparison topic of “payment” in the second row, the processing unit 10 will mark “FamilyMart, OK, HiLife cash on delivery, Post Express cash on delivery” in the entry corresponding to the second column. Corresponding to the comparison topic of “membership” in the third row, the processing unit 10 will mark “ordinary membership, group membership” in the entry corresponding to the second column.

Since the collected article further includes another collected article object “Yahoo”, the processing unit 10 uses the “Yahoo” as the content of the third column of the comparison table 17.

Further, the processing unit 10 marks the selected paragraph corresponding to each of the comparison topics in the collected article to the entries of the rows corresponding to each of the comparison topics within the third column.

As illustrated in FIG. 5, corresponding to the comparison topic of “third party payment processor” in the first row, the processing unit 10 will mark “Yahoo EasyPay” in the entry corresponding to the third column. Corresponding to the comparison topic of “payment” in the second row, the processing unit 10 will mark “WebATM transaction, ATM transaction, credit card” in the entry corresponding to the third column. Corresponding to the comparison topic of “membership” in the third row, the processing unit 10 will mark “ordinary membership, business membership” in the entry corresponding to the third column.

It is appreciated that only one collected article 15 is used as an example in the embodiment described above. In other embodiments, the processing unit 10 can retrieve a multiple of collected articles and perform the similar processing to make the article objects thereof as the contents of the columns of the comparison table and further mark the paragraphs or words in the entries corresponding to each of the comparison topics. Moreover, the objects related to the third party payment are used as an example in the embodiment described above. In other embodiments, various article objects and comparison topics can be used to generate the comparison table.

It is appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A comparison table automatic generation method implemented by a server, wherein the comparison table automatic generation method comprises:
receiving a setting of a plurality of comparison topics, a basic article, a basic article object and a plurality of marked paragraphs through an interface unit, wherein each of the marked paragraphs is selected from a paragraph of the basic article and is marked by one of the comparison topics;
calculating a first correlation between each of a plurality of basic article words comprised in each of the marked paragraphs through the server, and generating at least one marked main tag and a plurality of marked enriched words corresponding to each of the marked paragraphs;
retrieving a collected article and a collected article object from an information source according to the marked main tag and the marked enriched words through the server;
calculating a second correlation between each of a plurality of collected article words comprised in each of a plurality of collected article paragraphs through the server, and generating at least one main tag of collected article paragraph and a plurality of extend words of collected article paragraph;
generating a similarity by comparing the main tag of collected article paragraph and the extend words of collected article paragraph of each of the collected article paragraphs, to the marked main tag and the marked enriched words of each of the marked paragraphs through the server;
selecting a selected paragraph corresponding to each of the comparison topics from each of the collected article paragraphs according to the similarity;
establishing a comparison table through the server, wherein each of the comparison topics serves as a content of each of a plurality of rows of the comparison table, and the basic article topic serves as the content of one of a plurality of columns of the comparison table;
marking paragraphs corresponding to each of the comparison topics in the basic article to entries of the rows corresponding to each of the comparison topics within the column through the server;
using the collected article object as the content of another one of the plurality of columns of the comparison table; and
marking the selected paragraph corresponding to each of the comparison topics in the collected article to the entries of the rows corresponding to each of the comparison topics within the column.

2. The comparison table automatic generation method of claim 1, further comprising:
calculating a normalized Google distance (NGD) of each of the basic article words for calculating the first correlation between each of the basic article words through the server.

3. The comparison table automatic generation method of claim 1, further comprising:
performing a search through the server by using a search engine according to each of the marked enriched words to generate a search result page with a plurality of search result words, wherein one of the plurality of search result words are categorized into the marked enriched words when an importance value of the one of the plurality of search result words is larger than a importance threshold.

4. The comparison table automatic generation method of claim 1, wherein the marked main tag and the marked enriched words are retrieved from the basic article words when the first correlation is larger than a correlation threshold.

5. The comparison table automatic generation method of claim 4, further comprising:
when the first correlation is larger than a correlation threshold, retrieving the marked main tag through the server by using a k-core algorithm or a pagerank algorithm.

6. The comparison table automatic generation method of claim 1, further comprising:
calculating a normalized Google distance through the server according to the main tag of collected article paragraph and the marked main tag;
calculating a cosine similarity through the server according to the extend words of collected article paragraph and the marked enriched words;
generating the similarity through the server according to the normalized Google distance and the cosine similarity; and
when the similarity is larger than a similarity threshold value, determining that the comparison topic of the collected article paragraph and the comparison topic of the basic article paragraph are the same through the server.

7. The comparison table automatic generation method of claim 6, further comprising:
performing a sum of all of weight summation of the normalized Google distance and the cosine similarity through the server according to a first weighting value and a second weighting value to generate the similarity.

8. The comparison table automatic generation method of claim 1, further comprising:
retrieving a plurality of the collected articles from the information source and generating the selected paragraph corresponding to each of the comparison topic from each of the collected articles through the server;
making the collected article object of each of the collected articles serve as the content of one of the columns of the comparison table through the server; and
marking the selected paragraph corresponding to each of the comparison topics in the collected articles to the entries of the rows corresponding to each of the comparison topics within the columns through the server.

9. A comparison table automatic generation device comprising:
a storage unit configured to store an application program; and
a processing unit electrically coupled to the storage unit and configured to execute the application program to generate a comparison table automatically according to a basic article and a connected article collected within a time period;
wherein the processing unit provides an interface unit to receive a setting of a plurality of comparison topics, the basic article, a basic article object and a plurality of marked paragraphs, wherein each of the marked paragraphs is selected from a paragraph of the basic article and is marked by one of the comparison topics;
the processing unit is further configured for:
calculating a first correlation between each of a plurality of basic article words comprised in each of the marked paragraphs so as to control the server to generate at least one marked main tag and a plurality of marked enriched words corresponding to each of the marked paragraphs;
retrieving the collected article and a collected article object from an information source according to the marked main tag and the marked enriched words;
calculating a second correlation between each of a plurality of collected article words comprised in each of a plurality of collected article paragraphs, and generating at least one main tag of collected article paragraph and a plurality of extend words of collected article paragraph;
generating a similarity by comparing the main tag of collected article paragraph and the extend words of collected article paragraph of each of the collected article paragraphs, to the marked main tag and the marked enriched words of each of the marked paragraphs;
selecting a selected paragraph corresponding to each of the comparison topics from each of the collected article paragraphs according to the similarity;
establishing the comparison table, wherein each of the comparison topics serves as a content of each of a plurality of rows of the comparison table and the basic article topic serves as the content of one of a plurality of columns of the comparison table;
marking the marked paragraphs corresponding to each of the comparison topics in the basic article to entries of the rows corresponding to each of the comparison topics within the column;
using the collected article object as the title of another one of the plurality of columns of the comparison table; and
marking the selected paragraph corresponding to each of the comparison topics in the collected article to the entries of the rows corresponding to each of the comparison topics within the column.

10. The comparison table automatic generation device of claim 9, wherein the processing unit further calculates a normalized Google distance of each of the basic article words for calculating the first correlation between each of the basic article words.

11. The comparison table automatic generation device of claim 9, wherein the processing unit further performs a search by using a search engine according to each of the marked enriched words to generate a search result page with a plurality of search result words, wherein one of the search result words are categorized into the marked enriched words when an importance value larger of the one of the plurality of the search result words is than a importance threshold.

12. The comparison table automatic generation device of claim 9, wherein the marked main tag and the marked enriched words are retrieved from the basic article words when the first correlation is larger than a correlation threshold.

13. The comparison table automatic generation device of claim 12, wherein when the first correlation is larger than a correlation threshold, the processing unit further retrieves the marked main tag by using a k-core algorithm or a pagerank algorithm.

14. The comparison table automatic generation device of claim 9, wherein the processing unit is further configured for:
calculating a normalized Google distance according to the main tag of collected article paragraph and the marked main tag and controlling the server to calculate a cosine similarity according to the extend words of collected article paragraph and the marked enriched words;
generating the similarity according to the normalized Google distance and the cosine similarity; and
when the similarity is larger than a similarity threshold value, determining that the comparison topic of the collected article paragraph and the comparison topic of the basic article paragraph are the same.

15. The comparison table automatic generation device of claim 14, wherein the processing unit further performs a sum of all of weight summation of the normalized Google distance and the cosine similarity according to a first weighting value and a second weighting value to generate the similarity.

16. The comparison table automatic generation device of claim 15, wherein the processing unit is further configured for:
retrieving a plurality of the collected articles from the information source and generating the selected paragraph corresponding to each of the comparison topic from each of the collected articles;
making the collected article object of each of the collected articles serve as the content of one of the columns of the comparison table; and
marking the selected paragraph corresponding to each of the comparison topics in the collected articles to the entries of the rows corresponding to each of the comparison topics within the columns.

17. A computer program product configured to execute a comparison table automatic generation method implemented by a server, wherein the comparison table automatic generation method comprises:
receiving a setting of a plurality of comparison topics, a basic article, a basic article object and a plurality of marked paragraphs through an interface unit, wherein each of the marked paragraphs is selected from a paragraph of the basic article and is marked by one of the comparison topics;
calculating a first correlation between each of a plurality of basic article words comprised in each of the marked paragraphs through the server, so as to control the server to generate at least one marked main tag and a plurality of marked enriched words corresponding to each of the marked paragraphs;
retrieving a collected article and a collected article object from an information source according to the marked main tag and the marked enriched words through the server;
calculating a second correlation between each of a plurality of collected article words comprised in each of a plurality of collected article paragraphs through the server, and generating at least one main tag of collected article paragraph and a plurality of extend words of collected article paragraph;
generating a similarity by comparing the main tag of collected article paragraph and the extend words of collected article paragraph of each of the collected article paragraphs, to the marked main tag and the marked enriched words of each of the marked paragraphs through the server;
selecting a selected paragraph corresponding to each of the comparison topics from each of the collected article paragraphs according to the similarity;
establishing a comparison table through the server, wherein each of the comparison topics serves as a content of each of a plurality of rows of the comparison table, and the basic article topic serves as the content of one of a plurality of columns of the comparison table;
marking the marked paragraphs corresponding to each of the comparison topics in the basic article to entries of the rows corresponding to each of the comparison topics within the column through the server;
using the collected article object as the title of another one of the plurality of columns of the comparison table; and
marking the selected paragraph corresponding to each of the comparison topics in the collected article to the entries of the rows corresponding to each of the comparison topics within the column.
